(19) United States
(12) Patent Application Publication
(10) Pub. No.: US 2021/0034629 A1
(43) Pub. Date: Feb. 4, 2021

(54) NETWORKED INTERPERSONAL MATCHING APPLICATION, SYSTEM AND METHOD

(71) Applicant: Jeremy Deutsch, New York, NY (US)

(72) Inventor: Jeremy Deutsch, New York, NY (US)

(21) Appl. No.: 16/997,682

(22) Filed: Aug. 19, 2020

Related U.S. Application Data
(63) Continuation of application No. 15/675,994, filed on Aug. 14, 2017, now abandoned.
(60) Provisional application No. 62/374,340, filed on Aug. 12, 2016.

(51) Int. Cl. G06F 16/2457; H04L 29/08; G06Q 50/00

(52) U.S. Cl. CPC G06F 16/24575; G06Q 50/01; H04L 67/306

(57) ABSTRACT

A method for providing a social media matrix is disclosed. Leveraging the social media matrix between two or more users, matches are realized using one or more different categories based on profile information provided by the users.

### CROSS-REFERENCE TO RELATED APPLICATIONS

This application is a Continuation Application of U.S. application Ser. No. 15/675,994, entitled NETWORKED INTERPERSONAL MATCHING APPLICATION, SYSTEM AND METHOD, filed Aug. 14, 2017, which claims priority to U.S. Provisional Application Ser. No. 62/374,340 entitled NETWORKED INTERPERSONAL MATCHING APPLICATION, SYSTEM AND METHOD, filed Aug. 12, 2016.

### FIELD OF THE INVENTION

The disclosure is directed generally to computer-based matching applications, and, more particularly, to a networked interpersonal matching application, system and method.

### BACKGROUND OF THE DISCLOSURE

In a typical matching application, such as a dating app, matches are often made based on scoring according to like-answers from matched persons in certain profile categories. For example, a user may fill out a profile, wherein the user provides a variety of information, such as interests, geographic location, personality type, socioeconomic status, desired match characteristics, and the like. This profile is then matched against other profiles, and a matching score is generated. It is assumed that a higher matching score is indicative of a better match, and accordingly parties having higher match scores may be linked together, such as in a recommendation to pursue a date or relationship.

However, such known engines/apps do little to take into account the true needs and desires of the user, and further typically provide or no differentiation over the dozens of other interpersonal matching apps and engines that provide such matching. Moreover, such known apps provide no ability to target specific mismatches in one's profile which one desires in a match. That is, users may desire to be “matched” with a mismatched person.

Therefore, the need exists for an engine, app, system, and method of matching mismatched users in an interpersonal matching context.

### BRIEF DESCRIPTION OF THE DRAWINGS

This disclosure is illustrated by way of example and not by way of limitation in the accompanying figure(s). The figure(s) may, alone or in combination, illustrate one or more embodiments of the disclosure. Elements illustrated in the figure(s) are not necessarily drawn to scale. Reference labels may be repeated among the figures to indicate corresponding or analogous elements.

FIG. 1 illustrates an aspect of an exemplary embodiment of the present invention.

FIG. 2 illustrates a screen shot of a user interface of an exemplary app/application/Web interface.

FIG. 3 is a graphical illustration of a social media matrix database for two users.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

Exemplary embodiments are provided throughout so that this disclosure is sufficiently thorough and fully conveys the scope of the disclosed embodiments to those who are skilled in the art. Numerous specific details are set forth, such as examples of specific components, devices, and methods, to provide this thorough understanding of embodiments of the present disclosure. Nevertheless, it will be apparent to those skilled in the art that specific disclosed details need not be employed, and that exemplary embodiments may be embodied in different forms. As such, the exemplary embodiments should not be construed to limit the scope of the disclosure. In some exemplary embodiments, well-known processes, well-known device structures, and well-known technologies may not be described in detail.

The terminology used herein is for the purpose of describing particular exemplary embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The steps, processes, and operations described herein are not to be construed as necessarily requiring their respective performance in the particular order discussed or illustrated, unless specifically identified as a preferred order of performance. It is also to be understood that additional or alternative steps may be employed.

Although the terms first, second, third, etc. may be used herein to describe various elements, steps, components, regions, layers and/or sections, these elements, steps, components, regions, layers and/or sections should not be limited by these terms. These terms may be used only to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the exemplary embodiments.

Further, the described computer-implemented aspects are intended to be exemplary in the illustrated implementations and thus are not limiting. As such, it is contemplated that the herein described systems and methods can be adapted to provide many types of users, devices, and networking embodiments to provide enhancements and/or additions to the exemplary services described. Reference will now be made in detail to various exemplary and illustrative embodiments of the present invention.

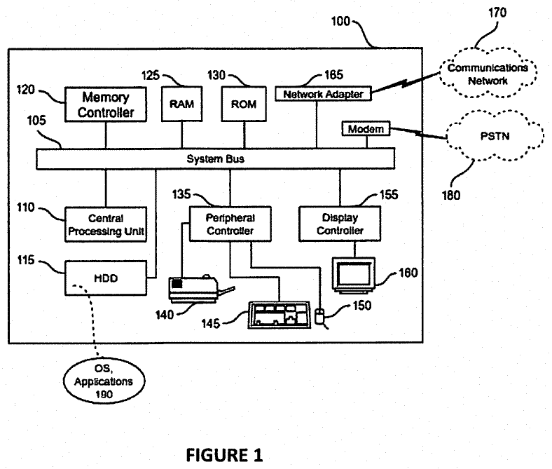

FIG. 1 depicts an exemplary computing system 100 that may be used in accordance with herein described system and methods. Computing system 100 is capable of executing software, such as an operating system (OS) and a variety of computing applications 190, and may likewise be suitable for operating hardware, such as one or more projectors connected via inputs/outputs (I/O), using said applications 190.

The operation of exemplary computing system 100 is controlled primarily by computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, mobile devices, and the like, CPU 110 is implemented in an integrated circuit called a processor.

The various illustrative logics, logical blocks, modules, and engines, described in connection with the embodiments disclosed herein may be implemented or performed with any of a general purpose CPU, a digital signal processor (DSP), an application specific integrated circuit (ASIC), a field programmable gate array (FPGA) or other programmable logic device, discrete gate or transistor logic, discrete hardware components, or any combination thereof, respectively acting as CPU 110 to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is appreciated that, although exemplary computing system 100 is shown to comprise a single CPU 110, such description is merely illustrative, as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium, such as HDD 115. Such instructions can be included in software, such as an operating system (OS), executable programs, and the like. Information, such as computer instructions and other computer readable data, is transferred between components of computing system 100 via the system's main data-transfer path. The main data-transfer path may use a system bus architecture 105, although other computer architectures (not shown) can be used, such as architectures using serializers and deserializers and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other communicative hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

The steps and/or actions described in connection with the aspects disclosed herein may be embodied directly in hardware, in a software module executed by a processor, or in a combination of the two, in communication with memory controller 120 in order to gain the requisite performance instructions. That is, the described software modules to perform the functions and provide the directions discussed herein throughout may reside in RAM memory, flash memory, ROM memory, EPROM memory, EEPROM memory, registers, a hard disk, a removable disk, a CD-ROM, or any other form of storage medium known in the art. Any one or more of these exemplary storage medium may be coupled to the processor 110, such that the processor can read information from, and write information to, that storage medium. In the alternative, the storage medium may be integral to the processor. Further, in some aspects, the processor and the storage medium may reside in an ASIC. Additionally, in some aspects, the steps and/or actions may reside as one or any combination or set of instructions on an external machine readable medium and/or computer readable medium as may be integrated through I/O port(s) 185, such as a “flash” drive.

In addition, computing system 100 may contain peripheral controller 135 responsible for communicating instructions using a peripheral bus from CPU 110 to peripherals and other hardware, such as printer 140, keyboard 145, and mouse 150. An example of a peripheral bus is the Peripheral Component Interconnect (PCI) bus.

One or more hardware input/output (I/O) devices 185 may be in communication with hardware controller 190. This hardware communication and control may be implemented in a variety of ways and may include one or more computer buses and/or bridges and/or routers. The I/O devices controlled may include any type of port-based hardware (and may additionally comprise software, firmware, or the like), and can include network adapters and/or mass storage devices from which the computer system can send and receive data for the purposes disclosed herein. The computer system may be in communication with the Internet via the I/O devices 185 and/or via communications network 170.

Display 160, which is controlled by display controller 155, can be used to display visual output generated by computing system 100. Such visual output may include text, graphics, animated graphics, and/or video, for example. Display 160 may be implemented with a CRT-based video display, an LED or LCD-based display, gas plasma-based display, touch-panel, or the like. Display controller 155 includes electronic components required to generate a video signal that is sent for display.

Further, computing system 100 may contain network adapter 165 which may be used to couple computing system 100 to an external communication network 170, which may include or provide access to the Internet, and hence which may provide or include tracking of and access to the domain data discussed herein. Communications network 170 may provide user access to computing system 100 with means of communicating and transferring software and information electronically, and may be coupled directly to computing system 100, or indirectly to computing system 100, such as via PSTN or cellular network 180. For example, users may communicate with computing system 100 using telecommunication means. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

It is appreciated that exemplary computing system 100 is merely illustrative of a computing environment in which the herein described systems and methods may operate, and thus does not limit the implementation of the herein described systems and methods in computing environments having differing components and configurations. That is, the inventive concepts described herein may be implemented in various computing environments using various components and configurations.

Those skilled in the art will appreciate that the user interfaces of the present invention may be provided in the aforementioned computing system 100 in any manner known to those skilled in the art. For example, the user interface may be provided as an aspect, such as a widget or the like, in association with a distinct, such as a thin-client, software engine, i.e., a “Web interface.” Similarly, the user interfaces and disclosed functions may be provided as a thick-client, such as via an “app” on a mobile device or application on a personal computer, or may be provided as an app/application in a combination of thick and thin client.

The inventive aspects may make use of a “social media matrix”. By way of non-limiting example, the matrix may be formatted as a relational database associated with the memory devices discussed in FIG. 1. Each aspect of the matrix may indicate a score for that specific aspect, or multiple aspects may all be encompassed in a single score, such as a categorical score. Moreover, each score may be indicative of any of a variety of predetermined factors, such as a match, a mismatch, a degree of separation, or the like.

Thereby, exemplary embodiments may allow for entry of a user profile which, rather than seeking matches in all categories, may indicate that matches in some categories are sought, mismatches in some categories are sought, and/or particular degrees of separation in some categories are sought, or any combination of the foregoing is sought, by way of non-limiting example. The user may elect one or more of such factors, such as independently or by a user-indicated prioritization, in the matrix in order to obtain typical or atypical interpersonal matching—that is, the user may desire to find a soul mate to marry as is the case with many so-called “dating apps”, or a married user may desire a personality type distinct from one's spouse and geographically located such that no common acquaintances are shared.

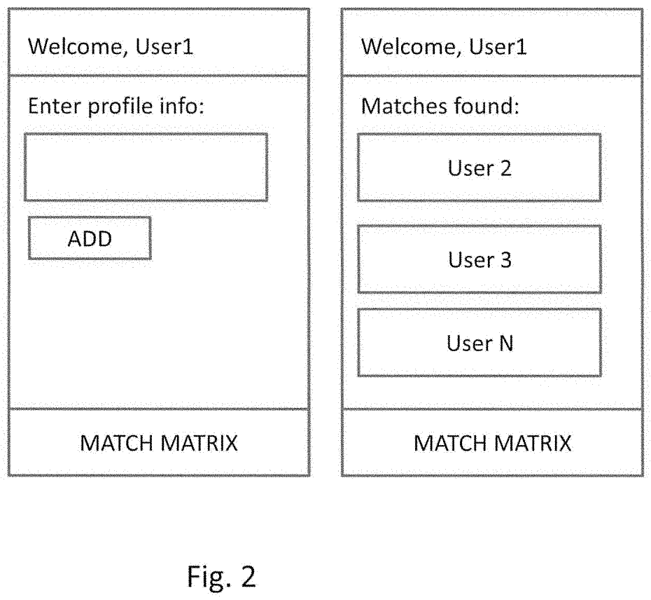

FIG. 2 illustrates a screen shot of a user interface of an exemplary app/application/Web interface as discussed herein. In the illustration, upon log-in a user may be presented with a modifiable profile. In the profile, the user may enter a variety of information about the user. Once or while the user's information is entered, the user may be asked to fill out a “match matrix” profile, in which, for one, several, or each factor entered by the user into the user's profile, the user may indicate whether he or she is seeking a match in that category, a mismatch in that category, a certain degree of separation in that category, etc. Once the user has completed, or partially or substantially completed, a profile and a match matrix, the user may be provided with matches (or mismatches) accordingly by actuation of the engine across large numbers of users, profiles, and across numerous network connections and device profiles. Of course, those skilled in the art will appreciate that not all factors may be available for the user to fill out the matrix, i.e., some aspects may be subjected only to the judgment of the disclosed app/application core.

The selection of a corresponding second user's profile to match with the first user may thereafter proceed as is known in the art. That is, once a second user is located who substantially matches the social media match matrix (and correspondent profile) provided by the first user, the first user and the second user may be linked. Furthermore, as will be apparent to those skilled in the art, this linking may also depend on the second user's social media match matrix and profile, .i.e., the linking may also depend on the second user's matrix of matches, mismatches, or degrees of separation by category.

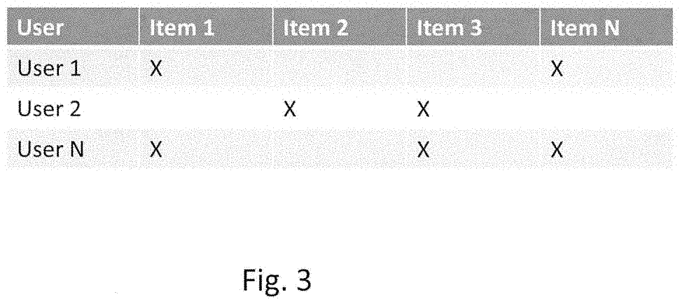

FIG. 3 is a graphical illustration of a social media matrix database for two users, labeled “User 1” and “User 2” in the figure. In the illustration, each user has provided answers to profile information, and has provided a match matrix indication correspondent to numerous factors in that respective user's profile. In the third aspect of the database illustrated in FIG. 3, a match level is indicated for each profile item and matrix item for each of users 1 and 2. Because the overall match matrix for the respective profiles and match matrices of users 1 and 2 is high in the overall match matrix database of FIG. 3 for the factors asserted as important to both users 1 and 2, users 1 and 2 may be matched to one another in the illustration.

Those skilled in the art will appreciate, in light of the discussion herein, the manner in which the disclosed exemplary embodiments may allow for optimization of user matches in manners heretofore unknown. For example, users may select particularly important aspects of the match matrix, such as degrees of separation in the “geographic location” factor, in order to obtain best matches for purposes unrealized in the known art. That is, in the example of FIG. 3, if user 1 and user 2 are both married to third parties, it may be particularly important to both user 1 and user 2 to have a high degree, but not too high of a degree so as to cause inconvenience, of geographic separation. That is, in the illustration geographic separation may receive a rating of 1 through 5 (the numeric ratings discussed are exemplary only, and hence are in no way limiting of the inventive aspects).

A rating of 1 may indicate that the users are within 0-5 miles of one another. A rating of 2 may indicate that the users are within 5-25 miles of one another. A rating of 3 may indicate that the users are within 25-50 miles of one another. A rating of 4 may indicate that the users are between 50 and 500 miles apart, and a rating of 5 may indicate that the users are more than 500 miles apart. Thereby, the match matrix selection by both user 1 and user 2 of a geographic degree of separation of 3 indicates that user 1 and user 2 would both like to be between 25 and 50 miles away from any match. This may be because, in this exemplary illustration, user 1 and user 2 are each married to third parties, and consequently do not want to share common acquaintances, do not want to encounter one another at a store or restaurant, or the like—and this likelihood is minimized by a 25-50 mile degree of geographic separation, without making dating overly inconvenient.

Those skilled in the art will appreciate the application of the foregoing to various other factors. For example, if user 1 is married in the illustration of FIG. 2 and that user's spouse is an attorney (which may be categorized as a “white collar” employment position, either within view of the user or within the disclosed core matching engine), user 1 may indicate that she wishes to be matched only to a second user who works in a “blue collar” position. Thereby, the match presented to user 1 will be ensured to not work in the same industry as the user's spouse.

In light of the foregoing, it should be apparent that the user may provide a baseline of what the user wants and does not want in a match in accordance with the user's profile and match matrix. That is, the user may be enabled to use the app/application provided herein in the manner typically known in the art, i.e., to find a close match, or may be enabled to use the app provided herein in a manner directly contrary to the known art, i.e., to purposefully find mismatches in categories deemed most important to the user.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A method for matching users remote from one another using remotely located, non-transitory, relational social media matrix computing code over at least one network, the method comprising:
receiving profile information from a plurality of users into the social media matrix;
matching a first user with a second user amongst the plurality of users based on the presence of at least particular mismatched received profile information, wherein the social media matrix includes:
which aspects of the received profile information are indicative of a desire for the particular mismatched received profile information; and
degrees of data separation regarding at least ones of the mismatched received profile information that provide a real world security of distinctions, corresponded to the degrees of data separation, to at least one of the matching users.

2. The method of claim 1, wherein all of the profile information is stored in the social media matrix.

3. The method of claim 2, wherein the social media matrix calculates at least one score relating the first user with the second user to assess the degrees of separation.

4. The method of claim 3, wherein the matching is based on the calculated score.

5. The method of claim 1, wherein the profile information includes geographical information.

6. The method of claim 1, wherein the matrix determines one or more mutual friends of the first and second user as part of the degrees of separation.

7. The method of claim 6, wherein the first and second user are not matched in response to determining at least one mutual friend between the first and second user.
